(19) United States
(12) Patent Application Publication
(10) Pub. No.: US 2016/0053985 A1
(43) Pub. Date: Feb. 25, 2016

(54) LED ILLUMINATION APPARATUS

(71) Applicant: HABEMIT INTERNATIONAL CO. LTD., Zhongli City (TW)

(72) Inventor: Chin-Wen WANG, Zhongli City (TW)

(21) Appl. No.: 14/515,538

(22) Filed: Oct. 16, 2014

(30) Foreign Application Priority Data
Aug. 21, 2014 (TW) 103128873

(51) Int. Cl. F21V 31/00; F21V 23/00; F21V 3/04; F21V 5/04

(52) U.S. Cl. CPC F21V 31/005; F21V 5/048; F21V 23/002; F21V 3/04; F21V 23/005

(57) ABSTRACT

An LED illumination apparatus includes a lens module, an illumination module and a sealing structure. The lens module includes a ring seat opened on both sides and a diffusion lens installed to a side of the ring seat. The illumination module is contained in the ring seat and includes an illumination unit configured to be corresponsive to the diffusion lens. The sealing structure is filled between the illumination module and an inner edge of the other side of the ring seat. The lens module and the illumination module are telescoped with each other and sealed by the sealing structure to achieve a waterproof effect.

### FIELD OF THE INVENTION

The present invention relates to an LED illumination apparatus (or a light engine), and more particularly to a waterproof LED illumination apparatus.

### BACKGROUND OF THE INVENTION

As the technology of LED advances, LED has been used extensively in various illumination purposes, particularly in outdoor illuminations, and the outdoor illumination has an issue of water resistance. Although conventional light sources come with a water-resisting mechanism, most water-resisting mechanisms are made of plastic components, and thus are unable to withstand prolonged sunlight exposure or environmental temperature change. Therefore, a general outdoor lamp covers the light source by a lampshade, and requires the procedure of removing the lampshade for the installation, maintenance, and repair of the lamp, and thus causing an inconvenient construction.

In view of the aforementioned problems of the prior art, the inventor of the present invention based on years of experience in the related industry to conduct extensive researches and experiments and provide a feasible solution in accordance with the present invention to overcome the problems of the prior art.

### SUMMARY OF THE INVENTION

Therefore, it is a primary objective of the present invention to provide a waterproof LED illumination apparatus.

To achieve the aforementioned objective, the present invention provides an LED illumination apparatus, comprising a lens module, an illumination module and a sealing structure. The lens module includes a ring seat opened on both sides and a diffusion lens installed on a side of the ring seat. The illumination module is contained in the ring seat, and the illumination module includes an illumination unit configured corresponsive to the diffusion lens. The sealing structure is filled between the illumination module and an inner edge of the other side of ring seat.

Preferably, the lens module includes an external cover having a port, and sheathed on the diffusion lens, and sealed with the ring seat, and the diffusion lens is protruded and exposed from the port. The diffusion lens has a gasket sheathed on an edge of the diffusion lens. The illumination module includes a power cord, and an end of the power cord is electrically coupled to the illumination unit, and the other end of the power cord is passed through and out from the sealing structure. The illumination module includes a thermal switch electrically coupled to the power cord and the illumination unit. The illumination module includes a ring frame opened on both sides, a vapor chamber and a translucent plate, and the illumination unit is contained in the ring frame, and the vapor chamber and the translucent plate cover both sides of the ring frame respectively, and the translucent plate is configured towards the diffusion lens, and the illumination unit is in contact with the vapor chamber. The vapor chamber has a chamber formed therein. The sealing structure is filled between the ring frame and the vapor chamber. The ring frame contains a positioning structure, and the positioning structure abuts an inner wall of the ring frame, and the illumination unit and the vapor chamber are embedded and fixed to the positioning structure. The translucent plate is fixed and coupled to the positioning structure. The illumination unit includes a control circuit board having an LED matrix installed on one side of the control circuit board, and the LED matrix is configured towards the translucent plate. The control circuit board has the vapor chamber attached on the other side of the control circuit board. The sealing structure is formed by curing a silicone.

In the LED illumination apparatus of the present invention, the sealing structure is sheathed on the lens module and the illumination module to achieve the waterproof effect, so as to prevent the plastic components from being exposed, and allow the LED illumination apparatus to be exposed and installed in an outdoor environment.

### BRIEF DESCRIPTION OF THE DRAWINGS

FIG. 1 is an exploded view of an LED illumination apparatus in accordance with a preferred embodiment of the present invention;

FIG. 2 is another exploded view of an LED illumination apparatus in accordance with a preferred embodiment of the present invention;

FIG. 3 is a perspective view of an LED illumination apparatus in accordance with a preferred embodiment of the present invention;

FIG. 4 is a cross-sectional view of an LED illumination apparatus in accordance with a preferred embodiment of the present invention;

FIG. 5 is another cross-sectional view of an LED illumination apparatus in accordance with a preferred embodiment of the present invention;

FIG. 6 is a bottom side view of an LED illumination apparatus in accordance with a preferred embodiment of the present invention;

FIG. 7 is a schematic view of a sealing structure installed in an LED illumination apparatus in accordance with a preferred embodiment of the present invention;

FIG. 8 is a further cross-sectional view of an LED illumination apparatus in accordance with a preferred embodiment of the present invention; and

FIG. 9 is a schematic view of installing an LED illumination apparatus of the present invention.

### DESCRIPTION OF THE PREFERRED EMBODIMENTS

The technical contents of the present invention will become apparent with the detailed description of a preferred embodiment accompanied with the illustration of related drawings as follows. It is noteworthy that same numerals are used for representing same respective elements in the drawings.

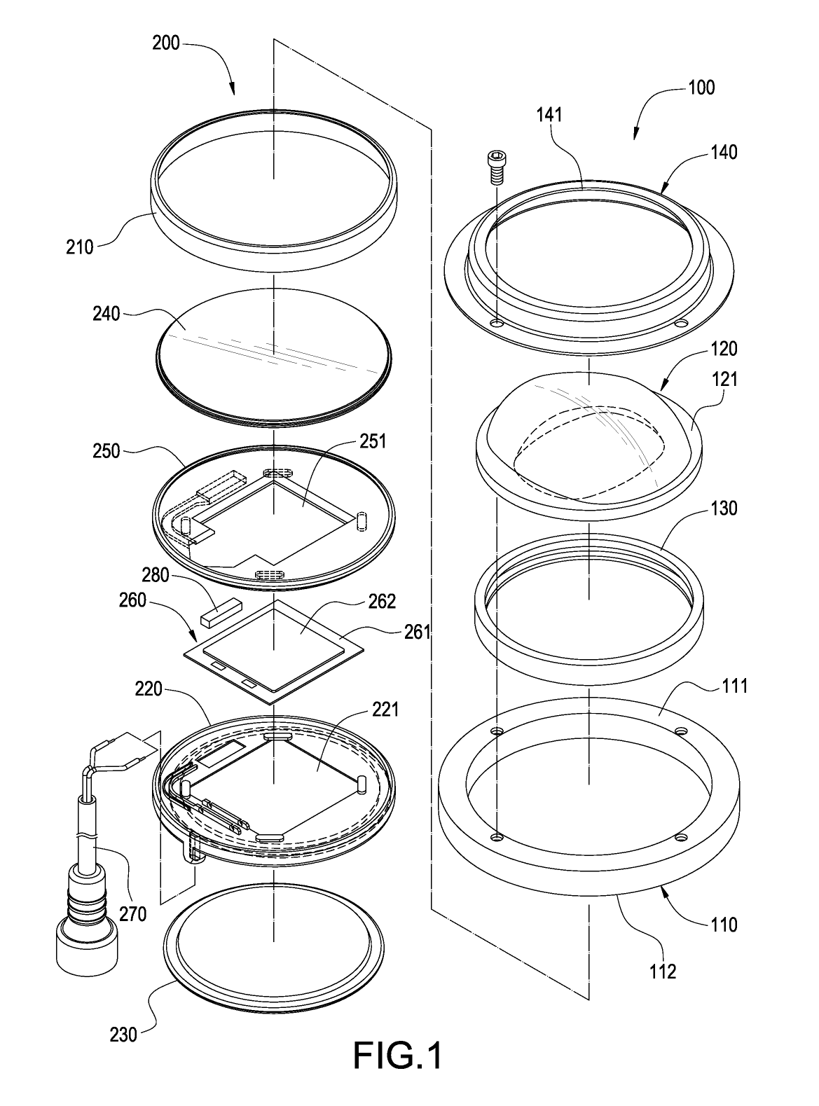

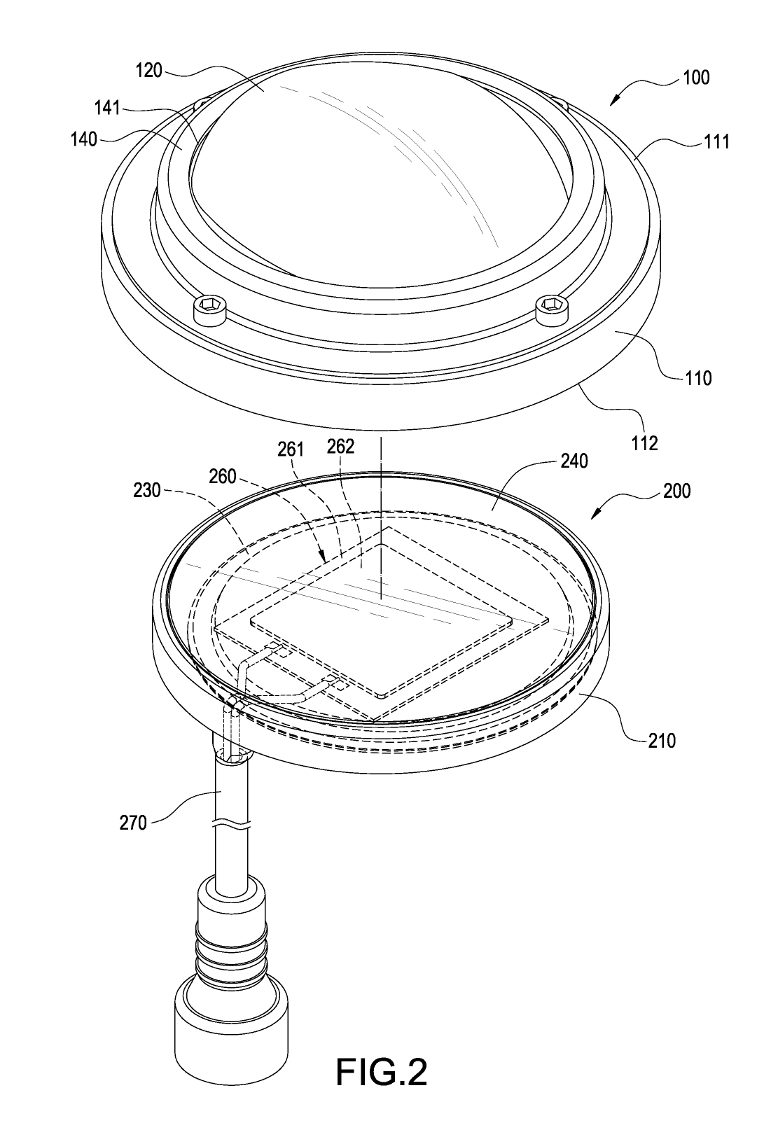

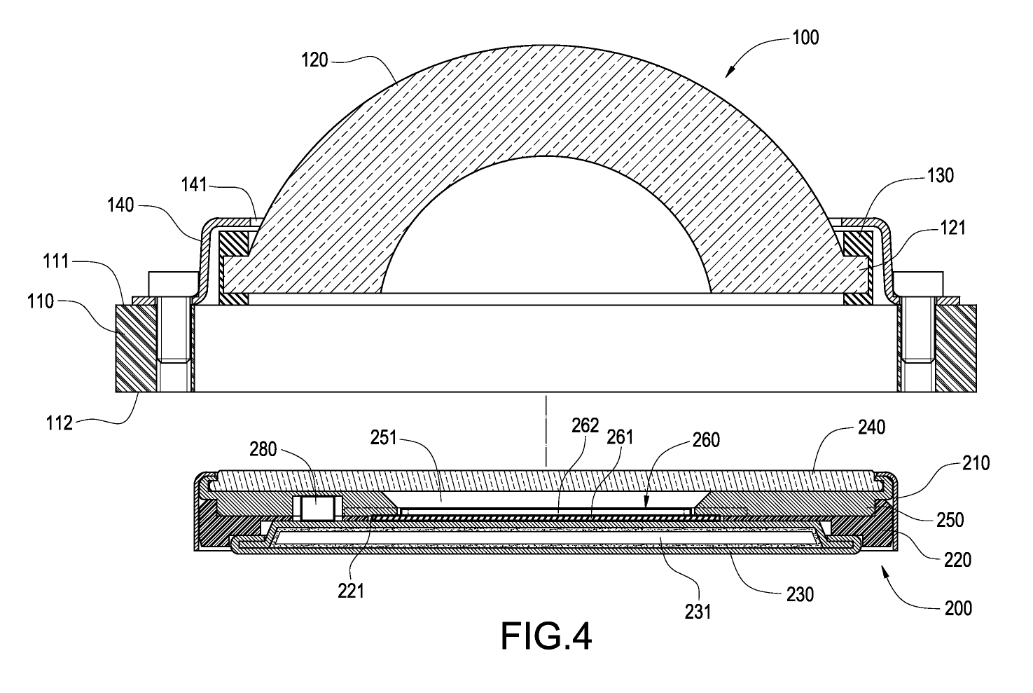

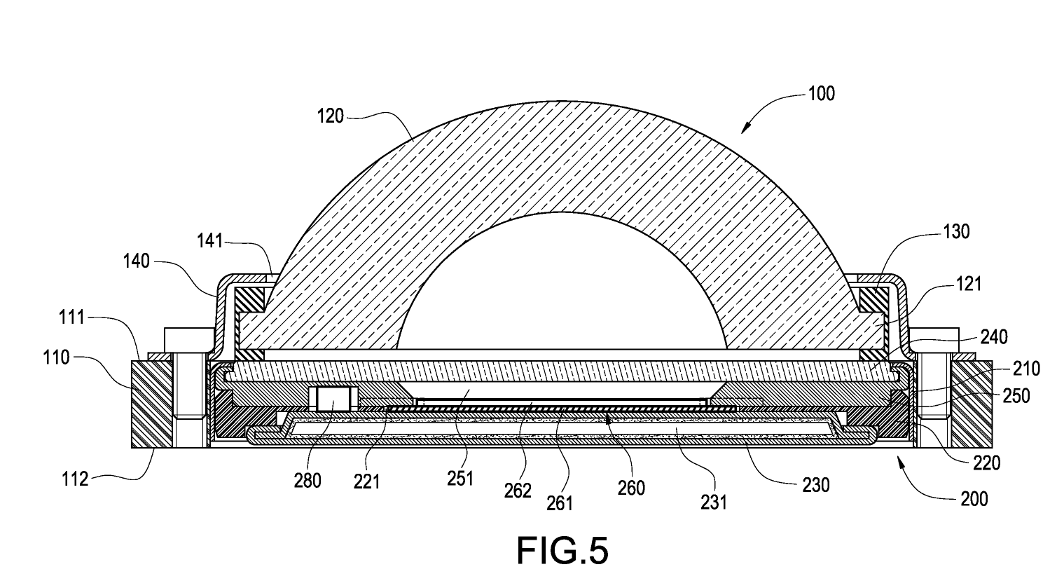

With reference to FIGS. 1 to 5 for an LED illumination apparatus in accordance with a preferred embodiment of the present invention, the LED illumination apparatus comprises a lens module 100 and an illumination module 200, and the lens module 100 is sheathed on the illumination module 200.

The lens module 100 includes a ring seat 110, a diffusion lens 120, a gasket 130 and an external cover 140. In this preferred embodiment, the ring seat 110 is preferably a circular seat opened on both sides which are a top side 111 and a bottom side 112 respectively. In the present invention, the shape of the ring seat 110 is not limited, and it may be a square ring seat or a ring seat of any other shape. The diffusion lens 120 is preferably a glass block installed at the top side 111 of ring seat 110, and an edge of the diffusion lens 120 is extended and protruded outwardly to form a flange 121. In the present invention, the shape of the diffusion lens 120 is not limited, and different shapes may be selected for different illumination applications. The gasket 130 is sheathed on the flange 121 of the diffusion lens 120 to cover the flange 121, so as to achieve the waterproof effect. The external cover 140 is locked to the top side 111 of the ring seat 110 to seal the top side 111 of the ring seat 110, and the external cover 140 includes a port 141 formed thereon, and the external cover 140 is sheathed on the diffusion lens 120 to fix the diffusion lens 120, and the diffusion lens 120 is passed through the port 141 and protruded and exposed from the external cover 140.

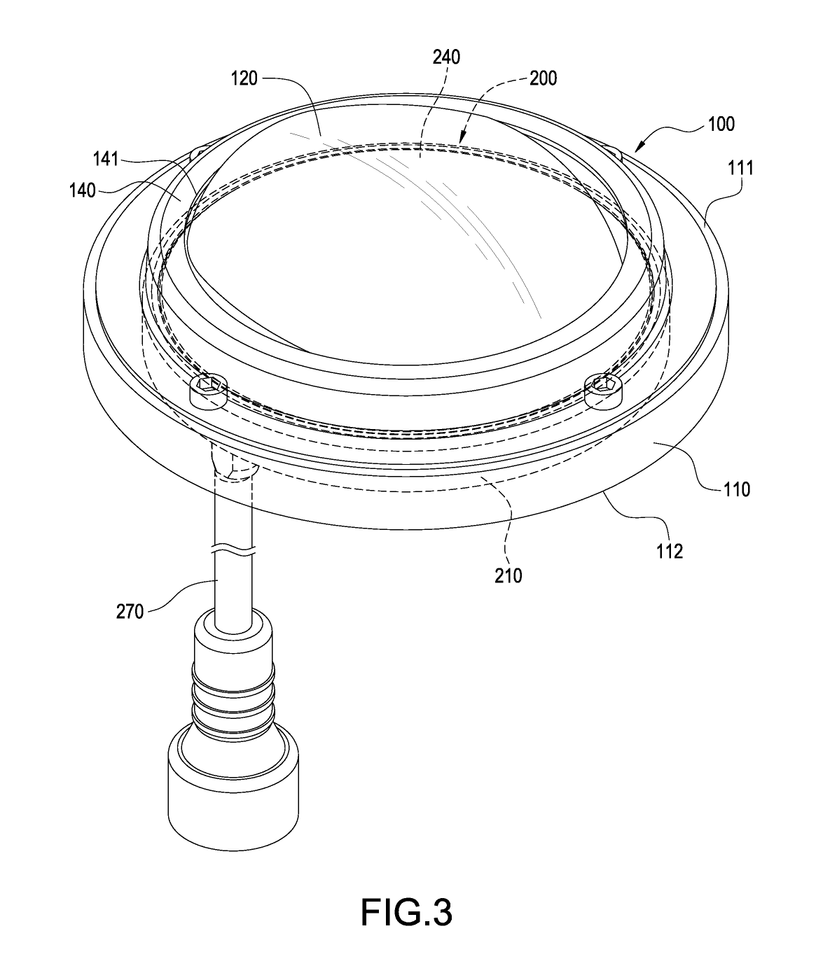

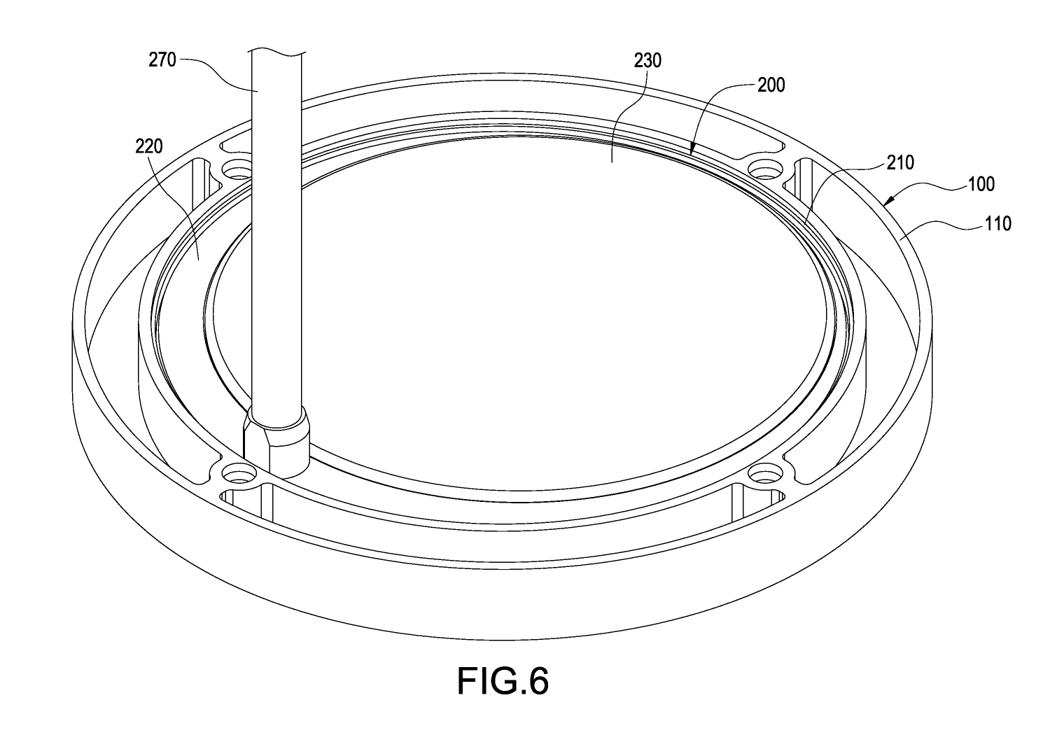

In FIGS. 3 to 6, the illumination module 200 is contained in the ring seat 110, and the illumination module 200 includes a ring frame 210, a positioning structure 220, a vapor chamber 230, a translucent plate 240, a thermally conductive plate 250, an illumination unit 260 (or a chip on board, COB), a power cord 270 and a thermal switch 280.

In this preferred embodiment, the ring frame 210 is preferably a circular ring frame 210 opened on both sides, but the present invention is not limited to a circular shape. The ring frame 210 preferably abuts at the ring seat 110, and the positioning structure 220, vapor chamber 230, translucent plate 240 and thermally conductive plate 250 are stacked with each other and fixed in the ring frame 210. The positioning structure 220 which is a plastic flat block, is contained in the ring frame 210, and the positioning structure 220 includes a positioning via 221 formed thereon, and an outer edge of the positioning structure 220 is pressed against an inner wall of the ring frame 210 and fixed in the ring frame 210. The vapor chamber 230 is preferably a copper flat member, and has a hollow interior to form a chamber 231, and the chamber 231 is filled with a working fluid. The vapor chamber 230 is embedded and fixed into one side of the positioning structure 220. In this preferred embodiment, the translucent plate 240 is a glass plate. However, the present invention is not limited to the glass plate only, but it can also be a transparent plastic plate as well. The thermally conductive plate 250 is an aluminum plate having a light via 251 formed thereon, and the thermally conductive plate 250 and the translucent plate 240 are stacked with each other, and the translucent plate 240 covers the light via 251. The translucent plate 240 is fixed and coupled to the other side of positioning structure 220 through the thermally conductive plate 250. Therefore, the vapor chamber 230 and the translucent plate 240 cover both sides of the ring frame 210 respectively, and the translucent plate 240 of the illumination module 200 is configured to be corresponsive to the diffusion lens 120. In this preferred embodiment, the illumination unit 260 includes a control circuit board 261 embedded and fixed into the positioning via 221 of the positioning structure 220, and one side of the control circuit board 261 has an LED matrix 262 disposed thereon, and the other side of the control circuit board 261 is attached onto the vapor chamber 230. The LED matrix 262 is configured towards the translucent plate 240 and disposed within the range of the light via 251, so that the LED matrix 262 is covered by the translucent plate 240 to achieve the waterproof effect. The power cord 270 is passed through the positioning structure 220, and an end of the power cord 270 is electrically coupled to the illumination unit 260, and the other end of the power cord 270 is passed through a gap between the ring frame 210 and the vapor chamber 230 and out from the illumination module 200. The power cord 270 is provided for electrically connecting to a mains power to supply electric power to the control circuit board 261, so that the LED matrix 262 is driven to emit light. The thermal switch 280 is embedded and fixed into the positioning structure 220 and electrically coupled to the power cord 270 and the illumination unit 260. If the illumination unit 260 is overheated, the thermal switch 280 cuts off the power supplied to the control circuit board 261.

A light source generated by the LED matrix 262 passes through the light via 251 of the thermally conductive plate 250 and the translucent plate 240 and projects onto the lens module 100, and the light source is refracted by the diffusion lens 120 and diffused into a predetermined light shape. The refraction from a diffusion lens 120 of a different shape produces a different light shape.

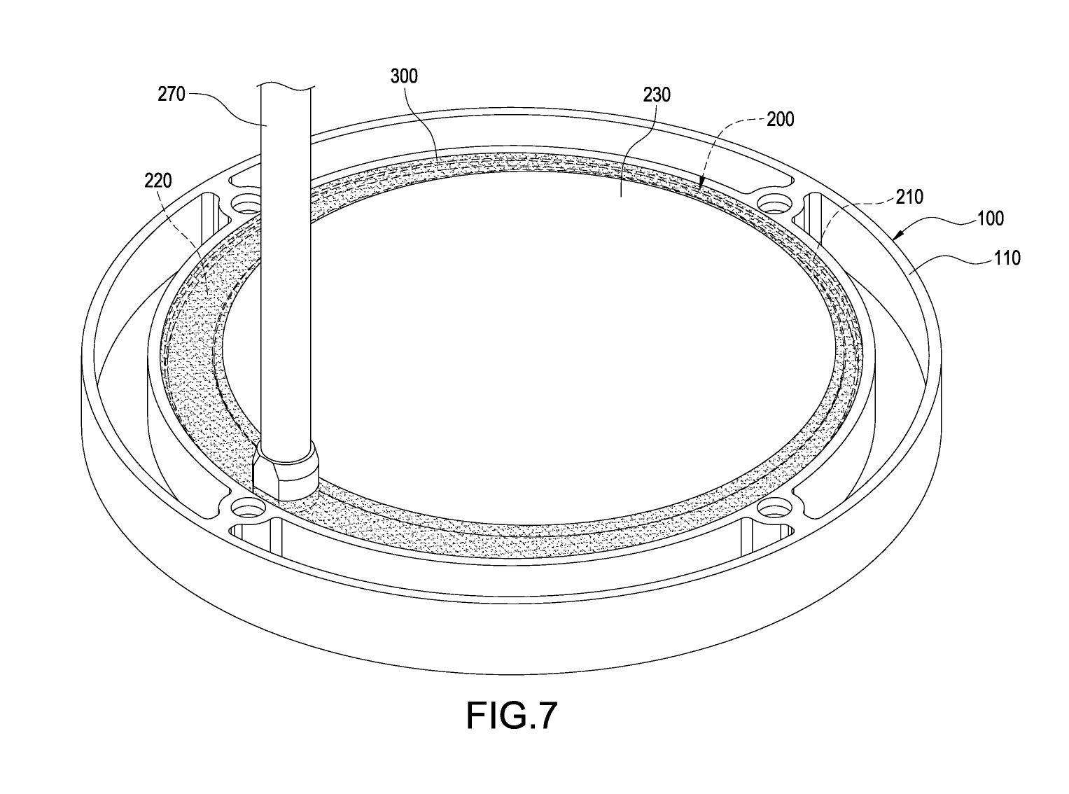

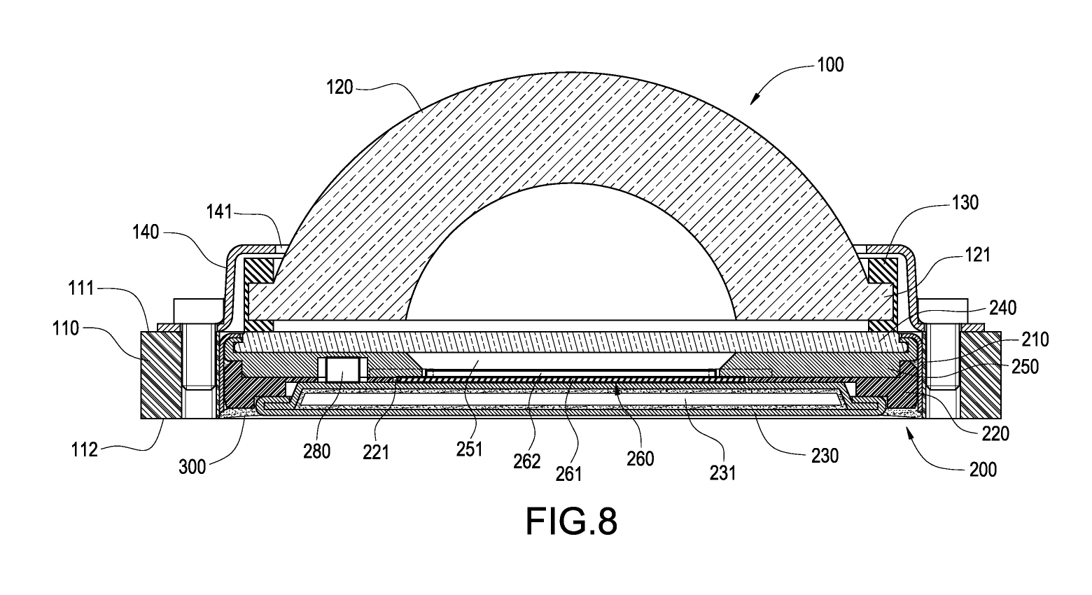

In FIGS. 7 and 8, an LED illumination apparatus of this preferred embodiment of the present invention comprises a sealing structure 300, which is preferably formed by covering and curing a silicone onto the bottom side 112 of the ring seat 110, and the sealing structure 300 is filled between the illumination module 200 and an inner edge of the bottom side 112 of the ring seat 110 and between the ring frame 210 and the vapor chamber 230, and the power cord 270 is passed through the sealing structure 300, so that the bottom side 112 of the ring seat 110 has a waterproof effect.

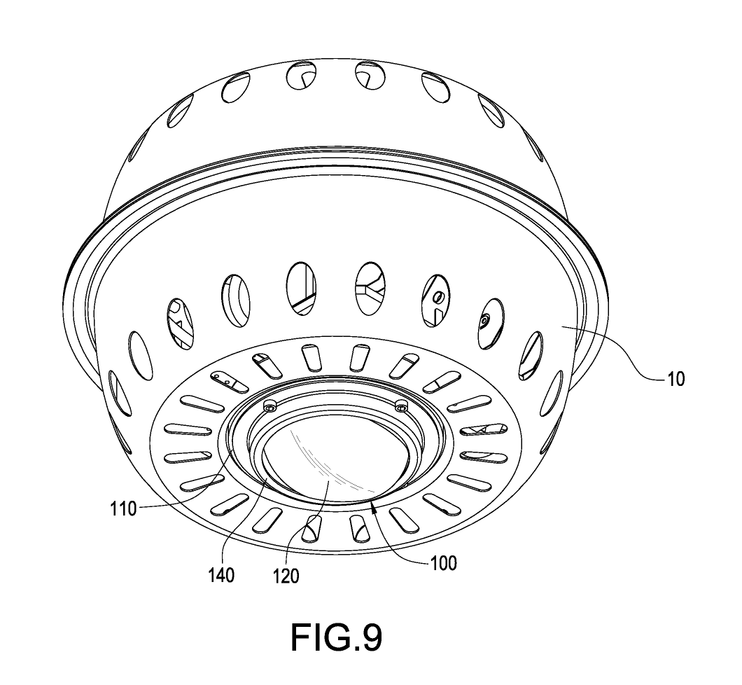

In FIG. 9, the LED illumination apparatus of the present invention is exposed from and installed to a lamp holder 10, and the lamp holder is disposed in an outdoor environment. In the LED illumination apparatus of the present invention, the positioning structure 220, translucent plate 240 and thermally conductive plate 250 are stacked with one another, so that the front side of the illumination module 200 has a waterproof effect, and the lens module 100 is sheathed on the illumination module 200 to prevent plastic components from being exposed to the sunlight, so as to prevent the plastic components from being aged and leaking due to the prolonged sunshine exposure. In addition, the LED illumination apparatus of the present invention further comprises the sealing structure 300 for sealing the lens module 100 and the illumination module 200, and the sealed position is disposed at the backside of the LED illumination apparatus, so as to provide the waterproof effect to the backside.

The plastic waterproof components of the LED illumination apparatus of the present invention are covered to prevent them from being aged quickly due to the environmental factors, so that the LED illumination apparatus can be exposed and installed in an outdoor environment.

While the invention has been described by means of specific embodiments, numerous modifications and variations could be made thereto by those skilled in the art without departing from the scope and spirit of the invention set forth in the claims.

What is claimed is:

1. An LED illumination apparatus, comprising:
a lens module, including a ring seat opened on both sides, and a diffusion lens installed on a side of the ring seat;
an illumination module, contained in the ring seat, and including an illumination unit configured to be corresponsive to the diffusion lens; and
a sealing structure, filled between the illumination module and an inner edge of the other side of the ring seat.

2. The LED illumination apparatus of claim 1, wherein the lens module includes an external cover having a port, and sheathed on the diffusion lens, and sealed with the ring seat, and the diffusion lens is protruded and exposed from the port.

3. The LED illumination apparatus of claim 2, wherein the diffusion lens has a gasket sheathed on an edge of the diffusion lens.

4. The LED illumination apparatus of claim 2, wherein the external cover locks the ring seat.

5. The LED illumination apparatus of claim 1, wherein the illumination module includes a power cord, and an end of the power cord is electrically coupled to the illumination unit, and the other end of the power cord is passed through and out from the sealing structure.

6. The LED illumination apparatus of claim 5, wherein the illumination module includes a thermal switch electrically coupled to the power cord and the illumination unit.

7. The LED illumination apparatus of claim 1, wherein the illumination module includes a ring frame opened on both sides, a vapor chamber and a translucent plate, and the illumination unit is contained in the ring frame, and the vapor chamber and the translucent plate cover both sides of the ring frame respectively, and the translucent plate is configured towards the diffusion lens, and the illumination unit is in contact with the vapor chamber.

8. The LED illumination apparatus of claim 7, wherein the vapor chamber has a chamber formed therein.

9. The LED illumination apparatus of claim 7, wherein the sealing structure is filled between the ring frame and the vapor chamber.

10. The LED illumination apparatus of claim 7, wherein the ring frame contains a positioning structure, and the positioning structure abuts an inner wall of the ring frame, and the illumination unit and the vapor chamber are embedded and fixed to the positioning structure.

11. The LED illumination apparatus of claim 10, wherein the translucent plate is fixed and coupled to the positioning structure.

12. The LED illumination apparatus of claim 7, wherein the illumination unit includes a control circuit board having an LED matrix installed on one side of the control circuit board, and the LED matrix is configured towards the translucent plate.

13. The LED illumination apparatus of claim 12, wherein the control circuit board has the vapor chamber attached on the other side of the control circuit board.

14. The LED illumination apparatus of claim 1, wherein the sealing structure is formed by curing a silicone.
